(19) United States
(12) Patent Application Publication
(10) Pub. No.: US 2017/0108150 A1
(43) Pub. Date: Apr. 20, 2017

(54) A FLEXIBLE METAL TUBE

(71) Applicant: National Oilwell Varco Denmark I/S, Brøndby (DK)

(72) Inventors: Morten Storgaard Nielsen, Copenhagen N (DK); Peter Søe Nielsen, Ølstykke (DK)

(21) Appl. No.: 15/308,111

(22) PCT Filed: May 7, 2015
(86) PCT No.: PCT/DK2015/050118

§ 371 Date: Nov. 1, 2016

(30) Foreign Application Priority Data
May 8, 2014 (DK) PA 2014 70276

(51) Int. Cl. F16L 11/16

(52) U.S. Cl. CPC F16L 11/16

(57) ABSTRACT

The present invention relates to flexible metal tube having a length and a longitudinal axis and suitable for forming a carcass of a flexible pipe for transport of hydrocarbons, the metallic tube comprises a plurality of consecutive windings of at least one elongate strip structure comprising a bearing structure and at least one cover flange. The cover flange is intended to cover the gaps which appear when the elongate strip is wound to form the flexible metal tube. When a fluid is flowing in the tube, open gaps may cause formation of vortexes in the flow of fluid which in most cases is undesired.

### TECHNICAL FIELD

The present invention relates to a flexible metal tube having a length and a longitudinal axis and suitable for forming a carcass of a flexible pipe for transport of hydrocarbons.

### BACKGROUND ART

Flexible offshore pipes are widely used for transport of hydrocarbons such as oil and gas. Basically a flexible pipe comprises an inner liner with a hollow bore through which the hydrocarbons are transported. The inner liner is in most cases produced from polymer material which is extruded to form a tubular liner, which has a high degree of impermeability in respect of the hydrocarbons to be transported. The inner liner may be supported and reinforced by several other layers, such as pressure armors and tensile armors. These layers are normally applied on the outer surface of the inner liner. However, due to external pressure it may sometimes be necessary to support the inner liner on the inner surface against collapse due to a pressure drop in the pipe bore. Normally, such a support is a metal structure known as a carcass. A carcass is conventionally made from elongate strips of metal, which are wound to form a tubular structure. The strips of metal may be wound with overlaps between consecutive windings to form the tube. Moreover, in their edge parts the metal strips may be provided with bends which may engage in consecutive windings and “lock” the windings to each other, thereby providing longitudinal strength to the resulting tube.

Consequently, flexible offshore pipes, hereafter referred to as flexible pipes, are for example used in the oil industry for raising or transporting hydrocarbons from a subsea well head to a platform or floating equipment such as a Floating Production and Storage Offloading unit known by the abbreviation FPSO. Such flexible pipes are for example described in “Recommended Practice for Flexible Pipe “API Recommended Practice 17 B”, fourth edition 2008 published by the American Petroleum Institute. Moreover, flexible pipes are also described in “Specification for unbonded flexible pipe” API 17J, third edition 2008″ or “Specification for Bonded Flexible Pipe”; API 17K, 2002, also published by the American Petroleum Institute.

Several types of carcasses have been applied to support the inner liner in a flexible pipe structure. The carcasses may be manufactured from elongate metal strips which may be folded into several different cross sections. The folded cross sections improve the strength in the resulting carcass.

However, these traditional carcass types will have a small gap between adjacent windings and when oil or gas is flowing in the flexible pipe, the oil or gas will be in contact with the carcass. Thus, when the flow reaches a certain velocity, the gaps between the adjacent windings may cause formation of local vortexes in the flow and the formation of these vortexes may again cause vibrations in the flowing gas as well as in the entire carcass structure and hence the flexible pipe. This phenomenon is known as “singing carcasses” and is highly undesirable as the vibrations may result in fatigue damage which is detrimental to the flexible pipe. When such vibrations appear, the vibrations may also spread to the connected structure comprising parts such as end fittings and connectors and cause severe damage on those parts.

Consequently attempts have been made to reduce or eliminate the formation of the vortexes. One very simple way to eliminate the formation of vortexes in the flow is to reduce the velocity of the flow of oil or gases in the flexible pipe. However, this solution will also reduce the capacity of the flexible pipe. Thus, alternative attempts have been made to avoid vortex formation at high flow velocities of oil and gas.

French patent application FR2930622 A1 discloses a method for eliminating vibrations by providing the strips from which the carcass is made with holes in the surface.

International patent application WO 2014/000816 A1 suggests a solution in which the gaps are provided with an insert profile, which at least partly closes the gaps between adjacent windings.

International patent application WO 2014/135906 A1 discloses a flexible metal pipe made from a layered strip. One of the layers in the strip may be un-folded and cover crevices in the flexible metal pipe. The structure makes it very difficult to achieve a pipe having a uniform diameter. To achieve a uniform diameter the layered strip needs to be modified by twisting or further bending which complicates the manufacture of the metal pipe.

Consequently, the known methods of avoiding “singing carcasses” are rather cumbersome and expensive to apply.

### DISCLOSURE OF INVENTION

An object of the present invention is to provide a flexible metal tube for forming a carcass with improved properties in respect of reducing vibrations.

Consequently, the present invention relates to a flexible metal tube having a length and a longitudinal axis and suitable for forming a carcass of a flexible pipe for transport of hydrocarbons, the metal tube comprises a plurality of consecutive windings of at least one profiled structure of an elongate strip and comprising a bearing structure and at least one cover flange, said bearing structure comprises a first and a second laterally folded side part, said first laterally folded side part in said plurality of consecutive windings is interlocked with said second laterally folded side part in respective adjacent windings allowing adjacent windings to move laterally a limited distance d relative to each other thereby allowing a maximum lateral gap between the first and the second laterally folded side part in adjacent windings, wherein said cover flange is integrated with and extends from said bearing structure to cover said lateral gap and where only one layer of the elongate strip constitutes the bearing structure and where engaging layers of the elongate strip are able to slide in respect of each other in directions substantially parallel to the longitudinal axis and directions substantially perpendicular to the longitudinal axis.

The profiled structure is preferable an S-shaped structure having the cover flange attached thereto. In an embodiment the S-shaped structure has two cover flanges attached.

The term “laterally folded side part” means that the folded side part is folded with a section in a direction substantially away from or towards the longitudinal axis and preferably with a second folded section substantially perpendicular to the longitudinal axis. In an embodiment the first laterally folded side part is a folded section facing away from the longitudinal axis and the second laterally folded side part is a folded section facing toward the longitudinally axis

The bearing structure is the part of the folded strip which does not comprise the cover flange. The bearing structure comprises only one layer of metal strip.

In an embodiment the cover flange is attached to the bearing structure in a section of the bearing structure which is adjacent to the first or the second laterally folded side part. Moreover, in an embodiment a cover flange is attached adjacent to the first and to the second laterally folded part.

In the metal tube the laterally folded side parts are interlocked and engage in a manner in which they are able to slide in respect of each other.

The fact that only one layer of the elongate strip constitutes the bearing structure serves to reduce the weight of the metal tube and makes the production of the metal tube or carcass less complicated.

The edges of the elongate strip comprise the folded parts, denoted the laterally folded parts. The edges of the elongate strip are the areas farthest away from the centre line in the longitudinal direction of the elongate strip. The folded parts are able to engage with adjacent windings and lock the windings together. Due to the forces in a flexible pipe it is advantageous to allow some flexibility between the adjacent windings and the windings are able to move laterally a distance d in respect of each other before the folded parts engage and block further lateral movements. The distance d may optionally be between 1 and 20 mm. Thus, in an embodiment the gap between adjacent windings have a maximum width of 20 mm, i.e. d is 20 mm for the maximum lateral gap, and the cover flange should have an extension of at least 20 mm to be able to cover the gap.

The flexible metal tube according to the invention is suitable for forming a carcass in a flexible pipe for transporting oil and gas. A flexible pipe for transporting oil and gas normally comprises from the inside to the outer side a carcass supporting an inner liner. The inner liner is covered with one or more layers of pressure armor, which again are covered with one or more layers of tensile armor and optionally the flexible pipe is covered with an outer liner constituting the outermost layer of the pipe.

To avoid gaps which may course formation of vortexes in the flexible metal tube when oil and gas are flowing, in an embodiment a cover flange extends from the bearing structure immediately adjacent to the first laterally folded side part in a first of the windings to cover the gap between the first winding and an adjacent interlocked winding. In this manner, the gaps between adjacent windings are covered by the cover flange, leaving no uneven structure for forming vortexes.

In an embodiment for avoiding the formation of vortexes in the flexible metal tube having an inner side facing the longitudinal axis, the cover flange conveniently extends to cover the lateral gap on the inner side of the tube.

In an embodiment the flexible metal tube having an outer side facing away from said longitudinal axis, the cover flange is located to extend to cover the lateral gap between adjacent windings on the outer side of the tube. This embodiment is able to reduce penetration of the inner liner into the carcass structure, thereby improving the flexibility of the flexible pipe. The penetration of the inner liner into the carcass structure may induce a “locking effect” which reduces the flexibility.

Moreover, in an embodiment the cover flanges are provided to cover the gaps both on the inside and the outer side of the flexible metal tube.

Thus, the present invention provides a simple and in-expensive way of avoiding the formation of vortexes in the flexible pipe when fluids such as oil or gas flow through the pipe.

The term “radial direction” means a direction from the axis of the metal tube and radially outwards.

The terms “laterally” and “lateral movement” mean a movement which is substantially parallel to the axis metal tube, i.e. a movement to the side.

The terms “inside” and “outside” a layer of the tubular member are used to designate the relative distance to the axis of the pipe, such that “inside a layer” means the area encircled by the layer i.e. with a shorter axial distance than the layer and “outside a layer” means the area not encircled by the layer and not contained by the layer, i.e. with a shorter axial distance than the layer.

Moreover, the term “inner side” means the side of a layer closest to the axis of the pipe, and “outer side” means the side of a layer farthest away from the axis of the pipe.

The term “substantially” should herein be taken to mean that ordinary product variances and tolerances are comprised.

It should be emphasized that the term “comprises/comprising” when used herein is to be interpreted as an open term, i.e. it should be taken to specify the presence of specifically stated feature(s), such as element(s), unit(s), integer(s), step(s) component(s) and combination(s) thereof, but does not preclude the presence or addition of one or more other stated features.

As mentioned the bearing structure of the strip forming the flexible metal tube is the folded structure of the elongate strip without the cover flange. Thus, the bearing structure corresponds to the structure of folded or profiled metal strips used for production of conventional carcasses.

The invention provides a flexible metal tube in which the elongate strip structure is formed from an elongate strip forming the bearing structure and where the cover flange is welded or alternatively glued to the bearing structure. Thus a conventional strip used for forming carcasses can be used, to which one or optionally two cover flanges are attached before or after profiling or winding the bearing structure. The one or two cover flanges are welded or glued to the strip or attached to the bearing structure by other means, such as by use of rivets.

Although, the cover flange is made from any suitable material such as plastics, polymer material or metal, the cover flange is suitably be made from the same material as the metal strip, i.e. the cover flange is made from metal, such as steel, and in an embodiment the cover flange is made from stainless steel. The cover flange is preferably made from a material and with a size and thickness which allows a certain flexibility of the cover flange, e.g. the cover flange should be able to bend or flex and be able to slide over other structures, such as the structure of the folded metal strip.

In an embodiment the flexible metal tube according to the invention is formed from an elongate strip structure which is formed from a strip with a first and a second edge, the strip is folded against itself at a distance from the first and the second edge to provide a protrusion or folded part. In the finally folded strip the first laterally folded side part comprises the first edge and the second laterally folded side part comprises at least a part of the protrusion and the cover flange. In this particular embodiment a flexible metal tube according to the invention is formed in a simple manner by folding a single layered metal strip.

To obtain a desired flexibility in the longitudinal direction along the longitudinal axis of the flexible metal tube, the interlocking between the first laterally folded side part and the second laterally folded side part in respective adjacent windings is a lateral interlocking, i.e. a locking in lateral direction.

The interlocking between the folded parts in the strip should allow flexibility and in an embodiment the interlocking between the first laterally folded side part and the second laterally folded side part in respective adjacent windings is a radial interlocking, i.e. a locking in radial direction.

For some embodiments it is desirable to have a very robust interlocking between the folded parts in the strip forming the flexible metal tube, and thus the interlocking between the first laterally folded side part and the second laterally folded side part in respective adjacent windings is a radial and lateral interlocking.

The interlocking ensures that the adjacent windings do not split apart, while the interlocking still allows the windings to slide in respect of each other.

In an embodiment the cover flange has a thickness different from the thickness of the bearing structure. In an embodiment the cover flange is made from thinner material than the material of the bearing structure, which makes it possible to reduce the weight of the metal tube. Thus, the cover flange may have a thickness ranging from about half the thickness of the bearing structure to about the thickness of the bearing structure. However, in an embodiment the cover flange has a thickness which is thicker than the thickness of the bearing structure. This embodiment is advantageously when the cover flange needs to have improved strength.

In an embodiment of the flexible metal tube cover flange comprises one or more protrusions and/or one or more recesses. Such protrusions and/or recesses serve to facilitate the flow of the fluid in metal tube.

In an embodiment the cover flange is curved. The cover flange is curved with vertex facing the axis of the pipe or curved with vertex facing the gap between adjacent windings. The curved cover flange provide improved strength and may also serve to facilitate the flow of the fluid in metal tube.

The elongate strip is preferably made from metallic material such as steel alloys, such as stainless steel.

### DESCRIPTION OF DRAWINGS

The invention will now be described in further details with reference to drawings, in which:

FIG. 1 shows a flexible pipe;

FIG. 2 shows a carcass for a flexible pipe;

FIG. 3 shows the structure of the carcass;

FIG. 4 shows a carcass on an inner liner;

FIG. 5 shows the carcass forming different gaps,

FIG. 6 shows the structure of a flexible tube according to the invention;

FIG. 7 shows an alternative structure;

FIG. 8 shows a structure of the flexible tube;

FIG. 9 shows a strip before bending;

FIG. 10 shows the strip during bending;

FIG. 11 shows the strip after bending;

FIG. 12 shows a strip before bending;

FIG. 13 shows the strip during bending;

FIG. 14 shows the strip after bending;

FIG. 15 shows an embodiment of a strip;

FIG. 16 shows a carcass structure with a strip as shown in FIG. 17; and

FIG. 17 shows an embodiment of a strip.

The drawings are only intended to illustrate the principles of the invention and are not dimensionally stable or accurate. The same reference numbers are used for the same parts in the drawings.

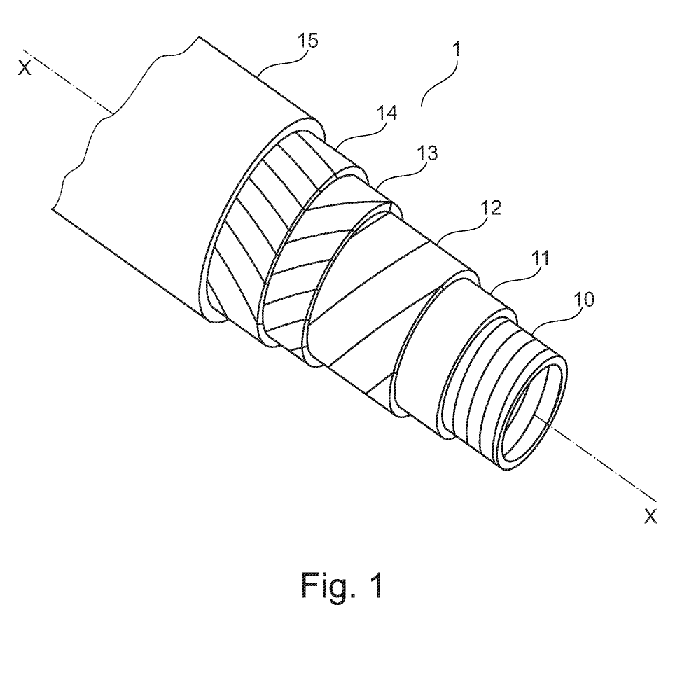

FIG. 1 shows a flexible pipe 1 having a longitudinal axis x-x. From the inside to the outer side the flexible pipe comprises a carcass 10 supporting an inner liner 11. The inner liner 11 is reinforced with a pressure armor layer 12 and two tensile armor layers 13, 14. The outer surface of the flexible pipe 1 is constituted by a protective sheath 15.

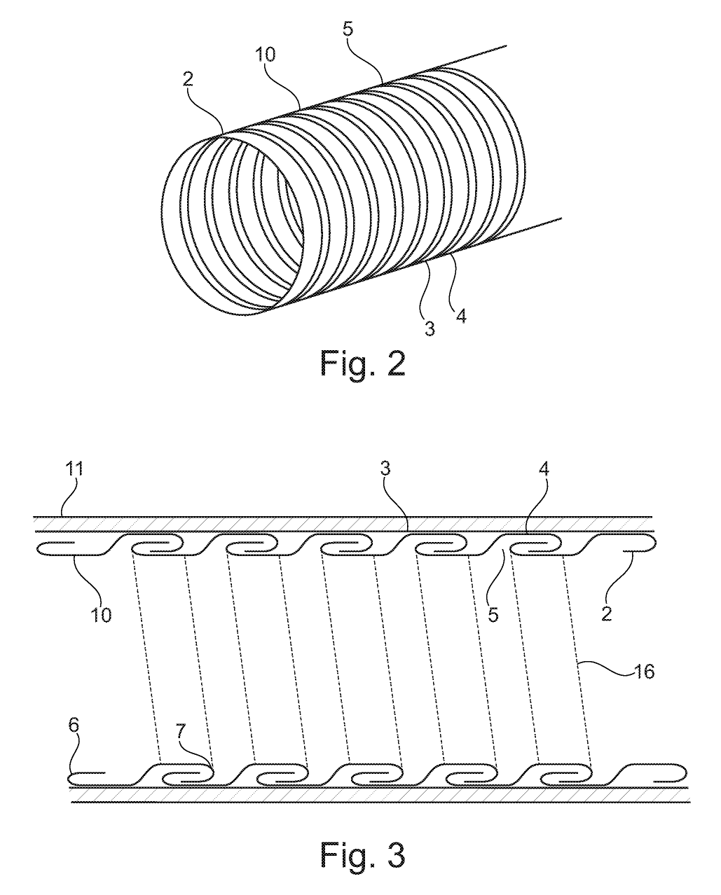

FIG. 2 shows a carcass 10 for a flexible pipe. The carcass 10 is produced as a flexible metal tube constituted by an elongated metal strip 2 wound into consecutive windings 3, 4. Between the consecutive windings 3, 4 a gap 5 is formed. The gap 5 serves to provide flexibility in the carcass 10, and, thereby, in the flexible pipe of which the carcass 10 is a part.

In FIG. 3 the structure of the carcass 10 is shown in more details. The carcass 10 is shown supporting an inner liner 11. As it may be seen the elongated metal strip 2 which forms the flexible tube constituting the carcass, has a first laterally folded side part 6 and a second laterally folded side part 7, which folded side parts are able to engage with consecutive windings 3, 4. The metal strip 2 having the first laterally folded side part 6 and the second laterally folded side part 7 constitute a bearing structure. A gap 5 is formed between the consecutive windings. The course or the windings are indicated by dotted lines 16.

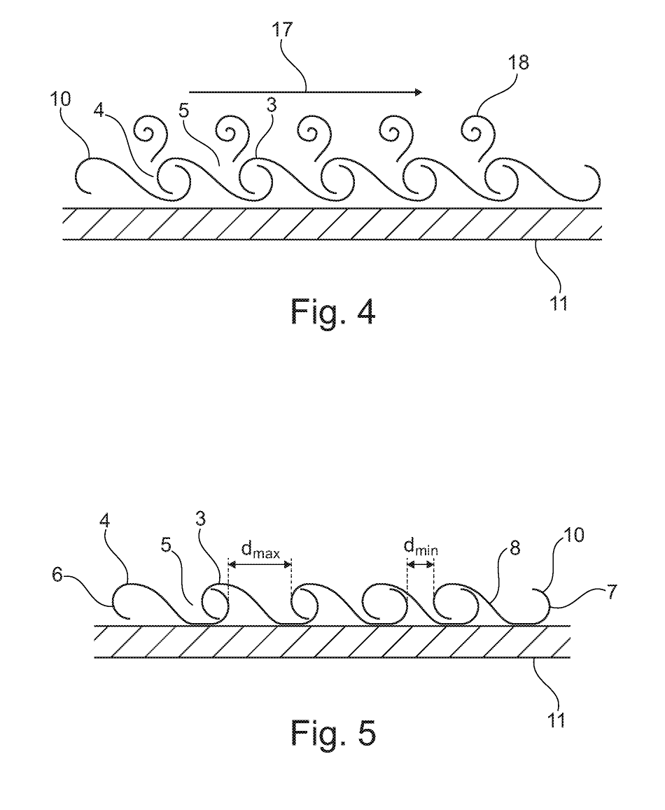

FIG. 4 also shows an example of the structure of a conventional carcass 10. The carcass 10 supports an inner liner 11, and the direction of flow of the fluid is indicated by arrow 17. The fluid may be oil and gas and when a flow of oil and gas is flowing through the flexible pipe of which the carcass 10 and the inner liner form parts, the gaps 5 formed between consecutive windings 3 and 4 may cause formation of vortexes 18. When these vortexes are formed they may give rise to vibrations, which may cause the entire structure of the flexible pipe to vibrate. To avoid the formation of vortexes it is necessary to reduce the velocity of the flow in the flexible pipe. By reducing the velocity of the flow the capacity of the flexible pipe is also reduced.

FIG. 5 illustrates the flexibility of the carcass 10. The figure shows that adjacent windings 3 and 4 are able to move with a lateral movement and slide in respect of each other. Thus, the gap 5 between two adjacent windings have a width providing a distance d which vary between dₘᵢₙ and dₘₐₓ. The range of the distance d i.e. the distance dₘᵢₙ to dₘₐₓ is determined by the folded parts 6, 7 and 8 of the metal strip 2. The range defined by dₘᵢₙ to dₘₐₓ is thus the range by which two adjacent windings move laterally in respect of each other and this range determines the flexibility of the metal tube.

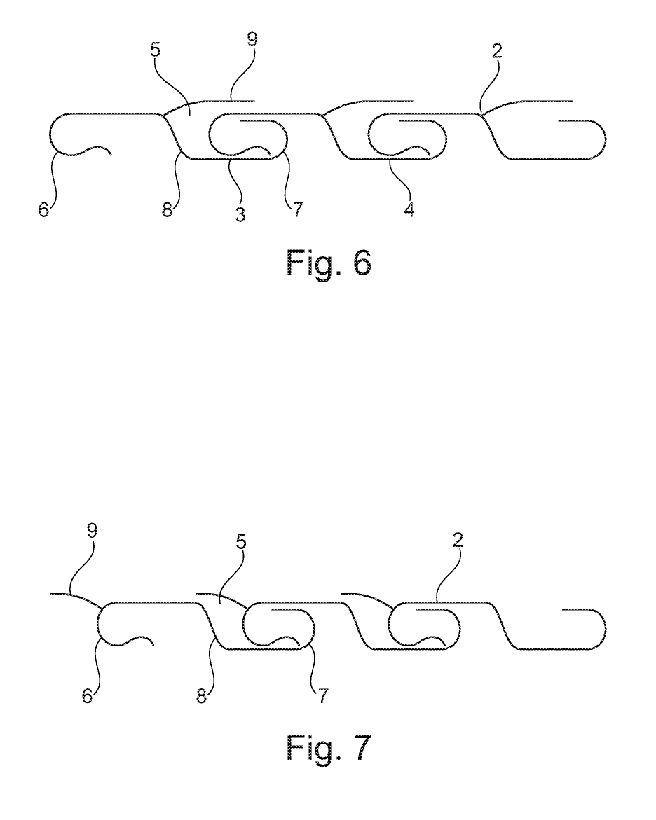

The FIGS. 6 and 7 illustrate embodiments of the present invention comprising cover flanges.

In FIG. 6 is shown a metal strip 2 which has a first laterally folded part 6 and a second laterally folded part 7. Moreover, the metal strip has a central folded portion 8. As it is clear from the above the first laterally folded part 6, the second laterally folded part 7, and the folded portion 8 are all well-known features in the metal strips used for making flexible metal tubes suitable for use as carcasses, and the parts constitute a bearing structure in a carcass.

However, the metal strip 2 has an additional feature, namely the cover flange 9, which is adapted to cover the gap 5 between two adjacent windings 3 and 4 when the metal strip is wound to form a tube. In the embodiment shown in FIG. 6 the cover flange 9 is placed in connection to the folded portion 9.

In the FIG. 7 the cover flange 9 is placed on the first laterally folded part 6. Otherwise, the metal strip 2 corresponds to the metal strip shown in FIG. 6. The cover flange 9 has a width which allows it to cover the gap 5 even when the two adjacent windings 3 and 4 are in a position in respect of each other in which they provide a maximum distance d between each other and a maximum width of the gap. When the cover flange covers the gap 5, the gap will not give rise to vortexes and the vibrations caused by the vortex formation.

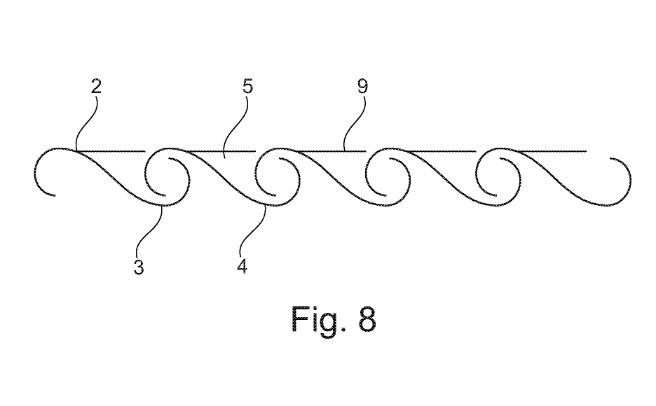

FIG. 8 shows the structure of a metallic tube according to the invention with adjacent windings 3, 4 of a metallic strip 2, which form a gap 5. The gap 5 is covered by the cover flange 9, and a substantially smooth surface is formed on one side of the metallic tube.

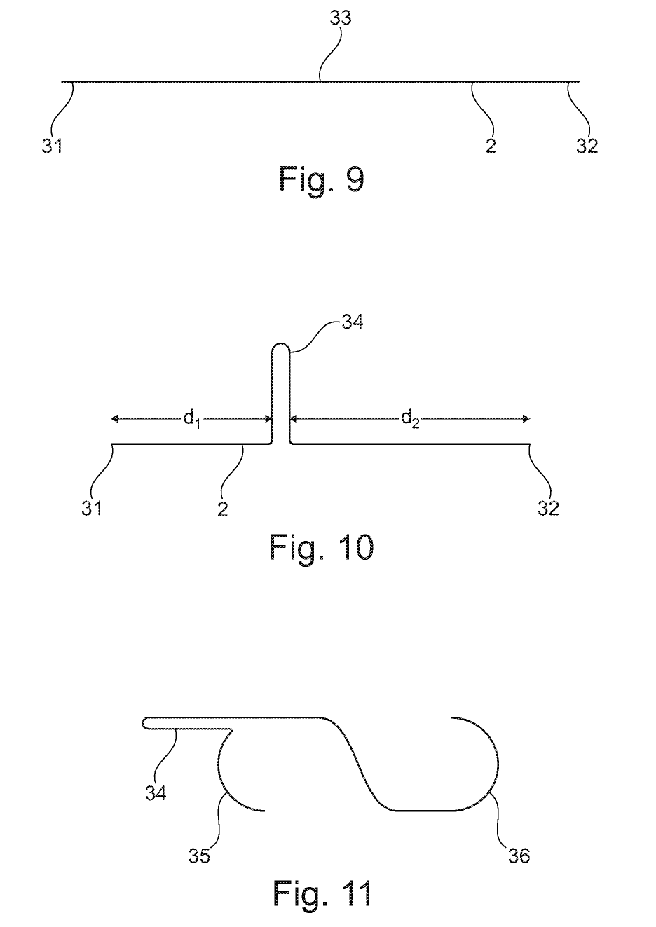

The FIGS. 9 to 14 schematically illustrate how a metal strip 2 is folded into a folded metal strip.

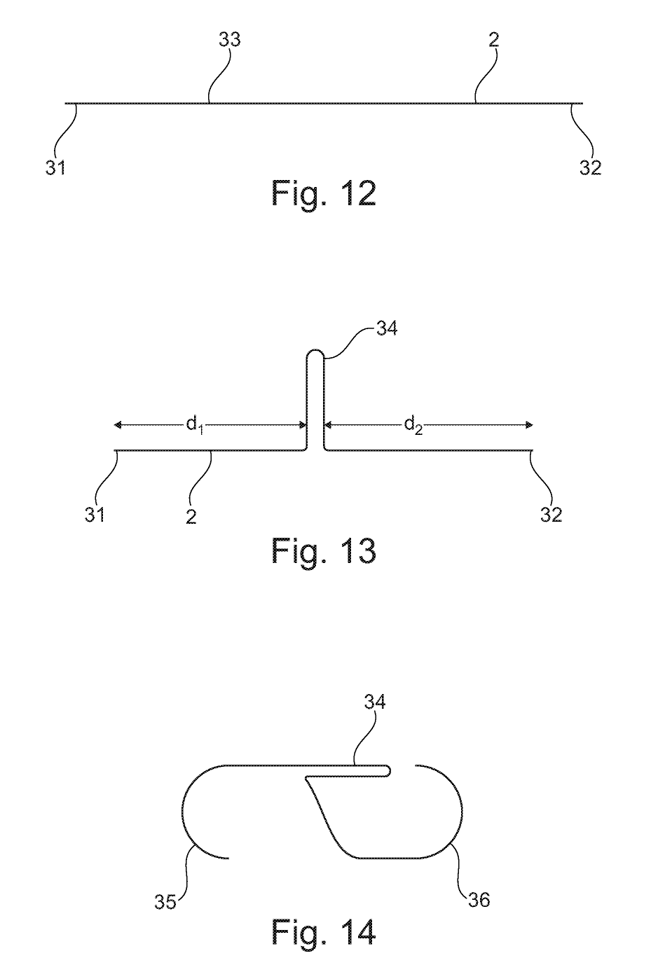

Before the folding as seen in FIGS. 9 and 12, the metal strip 2 comprises a first edge 31 and a second edge 32 and a substantially planar part 33 between the two edges.

In FIGS. 10 and 13 the metal strip 2 is folded against itself in the planar part 33 to form a protrusion 34. The protrusion 34 is formed at a distance d₁ from the first edge 31 and at a distance d₂ from the second edge 32. The distances d₁ and d₂ may be different or the same depending on the final design of the folded metal strip.

In FIGS. 11 and 14 the metal strip 2 has been folded to the final design with a first laterally folded part 35 and a second laterally folded part 36. In the final design the protrusion 34 forms a cover flange. The FIGS. 11 and 14 show two different designs of the structure of the metal strip according to the invention.

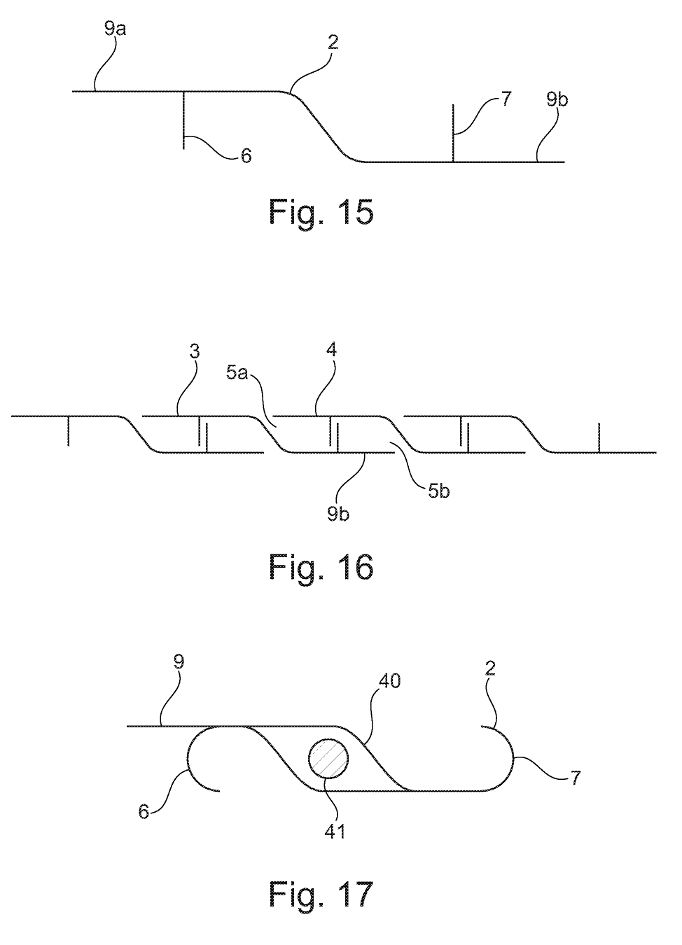

FIG. 15 shows a special design of a strip 2 according to the invention having to cover flanges 9a and 9b and a first laterally folded part 6 and a second laterally folded part 7. The first laterally folded part 6 and the second laterally folded part 7 are shaped with a substantially linear cross section. When the strip is wound to form a tubular structure such a linear shape will allow adjacent windings to move in radial direction in respect of each other.

This can be seen in FIG. 16 which shows the strip 2 forming a carcass structure. As it can be seen, the adjacent windings 3 and 4 are able to move both laterally and in radial direction in respect of each other. It can be seen that the two cover flanges 9a and 9b cover two gaps 5a and 5b formed between adjacent windings 3 and 4.

If the surface of the wound strip 2 in which the gaps 5a are present is considered to be the interior surface of the tubular carcass, the opposite surface in which the gaps 5b are present will be the exterior surface. The exterior surface of the carcass will be facing the inner liners as illustrated in e.g. FIG. 3, and normally it will not be necessary to cover the gaps 5b as these gaps will be covered by the inner liner. However, in some cases an embodiment as shown in the FIGS. 15 and 16 may be useful, e.g. when the velocity of the fluids is high.

FIG. 17 shows an embodiment of a folded strip 2 having a closed structure 40, which houses an optical wire 41 or other devices which may be desirable to include in the folded strip. The strip 2 comprises a first laterally folded part 6 and a second laterally folded part 7 which are adapted to engage with consecutive windings of the strip. The first laterally folded part 6 further comprises a cover flange 9 intended to cover the gap which appears when the strip is wound with consecutive windings to form a tubular structure.

The present invention provides a simple and efficient way of avoiding “singing carcasses” which may be realized at low-cost and with only minor modifications to the tool used for the production of carcasses. The above described embodiments are only examples and they may be modified to other embodiments by a skilled person. Consequently the scope of the invention is defined in the claims.

1. A flexible metal tube having a length and a longitudinal axis and suitable for forming a carcass of a flexible pipe for transport of hydrocarbons, the metal tube comprises a plurality of consecutive windings of at least one profiled structure of an elongate strip and comprising a bearing structure and at least one cover flange, said bearing structure comprises a first and a second laterally folded side part, said first laterally folded side part in said plurality of consecutive windings is interlocked with said second laterally folded side part in respective adjacent windings allowing adjacent windings to move laterally a limited distance d relative to each other thereby allowing a maximum lateral gap between the first and the second laterally folded side part in adjacent windings, wherein said cover flange is integrated with and extends from said bearing structure to cover said lateral gap and where only one layer of the elongate strip constitutes the bearing structure and where engaging layers of the elongate strip are able to slide in respect of each other in directions substantially parallel to the longitudinal axis and directions substantially perpendicular to the longitudinal axis.

2. The flexible metal tube of claim 1, wherein said cover flange extends from said bearing structure immediately adjacent to said first laterally folded side part in a first of said windings to cover the gap between said first winding and an adjacent interlocked winding.

3. The flexible metal tube of claim 1 having an inner side facing said longitudinally axis, wherein said cover flange extends to cover said lateral gap on said inner side of the tube.

4. The flexible metal tube of claim 1 having an outer side facing away from said longitudinal axis, wherein said cover flange extends to cover said lateral gap on said outer side of the tube.

5. The flexible metal tube of claim 1 wherein said elongate strip structure is formed from a strip forming the bearing structure and where the cover flange is welded to the bearing structure.

6. The flexible metal tube of claim 1 wherein said elongate strip structure is formed from a strip with a first and a second edge, the strip is folded against itself at a distance from said first and second edge to provide a protrusion, said first laterally folded side part comprises said first edge and said second laterally folded side part comprises at least a part of said protrusion and said cover flange.

7. The flexible metal tube of claim 1 wherein said interlocking between said first laterally folded side part and said second laterally folded side part in respective adjacent windings is a lateral interlocking.

8. The flexible metal tube of claim 1 wherein said interlocking between said first laterally folded side part and said second laterally folded side part in respective adjacent windings is a radial interlocking.

9. The flexible metal tube of claim 1 wherein said interlocking between said first laterally folded side part and said second laterally folded side part in respective adjacent windings is a radial and lateral interlocking.

10. The flexible metal tube of claim 1 wherein the cover flange has a thickness different from the thickness of the bearing structure.

11. The flexible metal tube of claim 1 wherein the cover flange comprises one or more protrusions and/or one or more recesses.

12. The flexible metal tube of claim 1 wherein the cover flange is curved.
